(19) United States
(12) Patent Application Publication
(10) Pub. No.: US 2013/0223907 A1
(43) Pub. Date: Aug. 29, 2013

(54) IMAGE FORMING APPARATUS

(71) Applicant: FUJI XEROX CO., LTD., (US)

(72) Inventors: Wataru SUZUKI, Kanagawa (JP); Masahiro SATO, Kanagawa (JP); Tetsuji OKAMOTO, Kanagawa (JP); Koichi WATANABE, Kanagawa (JP); Atsushi OGIHARA, Kanagawa (JP); Shuichi NISHIDE, Kanagawa (JP); Atsuyuki KITAMURA, Kanagawa (JP)

(73) Assignee: FUJI XEROX CO., LTD., Tokyo (JP)

(21) Appl. No.: 13/648,820

(22) Filed: Oct. 10, 2012

(30) Foreign Application Priority Data
Feb. 29, 2012 (JP) 2012-044203

(51) Int. Cl. G03G 15/00

(52) U.S. Cl. 399/388

(57) ABSTRACT

An image forming apparatus includes an image carrier that carries a developer image, a recording-medium transporting member that is movable between an opposing position at which the transporting member opposes the image carrier and a retracted position that is farther from the image carrier than the opposing position and includes a holding portion that holds a leading end of a recording medium, a retaining portion that is movable between a retaining position at which the retaining portion retains a trailing end of the recording medium and a separate position that is farther from the transporting member than the retaining position, a transfer unit that transfers the developer image onto the recording medium, and an allowing unit that allows the transporting member to be separated from the retaining portion when the transporting member is moved from the opposing position to the retracted position.

### CROSS-REFERENCE TO RELATED APPLICATIONS

This application is based on and claims priority under 35 USC 119 from Japanese Patent Application No. 2012-044203 filed Feb. 29, 2012.

### BACKGROUND

The present invention relates to an image forming apparatus.

### SUMMARY

According to an aspect of the invention, there is provided an image forming apparatus including an image carrier, a recording-medium transporting member, a retaining portion, a transfer unit, and an allowing unit. The image carrier is rotatably provided to an apparatus body and carries a developer image. The recording-medium transporting member is configured to be movable between an opposing position at which the recording-medium transporting member opposes the image carrier and a retracted position that is farther from the image carrier than the opposing position. The recording-medium transporting member includes a holding portion that holds a leading end of a recording medium, the recording medium being wrapped around an outer peripheral surface of the recording-medium transporting member. The retaining portion is configured to be movable between a retaining position at which the retaining portion retains a trailing end of the recording medium and a separate position that is farther from the recording-medium transporting member than the retaining position. The retaining portion rotates together with the recording-medium transporting member after retaining the trailing end of the recording medium. The transfer unit transfers the developer image carried by the image carrier onto the recording medium retained by the recording-medium transporting member at the opposing position. The allowing unit allows the recording-medium transporting member to be separated from the retaining portion so that the retaining portion does not interfere with a transport path of the recording medium when the recording-medium transporting member is moved from the opposing position to the retracted position.

### BRIEF DESCRIPTION OF THE DRAWINGS

Exemplary embodiments of the present invention will be described in detail based on the following figures, wherein:

FIG. 1 illustrates the overall structure of an image forming apparatus according to a first exemplary embodiment of the present invention;

FIGS. 2A and 2B illustrate the image forming apparatus according to the first exemplary embodiment of the present invention in the states in which a transfer drum is at an opposing position and a retracted position, respectively;

FIG. 3A illustrates a leading-end gripper and a trailing-end gripper in a plan view of the transfer drum according to the first exemplary embodiment of the present invention;

FIG. 3B illustrates the transfer drum according to the first exemplary embodiment of the present invention viewed in an axial direction;

FIGS. 4A and 4B illustrate the trailing-end gripper according to the first exemplary embodiment of the present invention in an open state and a closed state, respectively;

FIG. 5A is a perspective view of the transfer drum according to the first exemplary embodiment of the present invention;

FIG. 5B is a perspective view of an allowing portion provided at an end of the trailing-end gripper according to the first exemplary embodiment of the present invention;

FIGS. 6A, 6B, 6C, and 6D illustrate a transporting operation in which a sheet of recording paper is transported by the transfer drum according to the first exemplary embodiment of the present invention;

FIG. 7A illustrates the state in which the transporting operation is stopped while the leading end of the sheet of recording paper is at the trailing-end gripper according to the first exemplary embodiment of the present invention;

FIG. 7B illustrates the state in which the transporting operation is stopped while the leading end of the sheet of recording paper is at a separating member according to the first exemplary embodiment of the present invention;

FIGS. 8A and 8B illustrate the image forming apparatus according to the first exemplary embodiment of the present invention in the states in which the transfer drum is at the opposing position and the retracted position, respectively, after transportation of the sheet of recording paper is stopped in the middle of the transporting operation;

FIGS. 9A and 9B illustrate the image forming apparatus according to the first exemplary embodiment of the present invention in the states in which the trailing-end gripper is at a retaining position and a separate position, respectively;

FIGS. 10A and 10B illustrate an image forming apparatus according to a second exemplary embodiment of the present invention in the states in which a transfer drum is at an opposing position and a retracted position, respectively;

FIG. 11A illustrates a trailing-end gripper according to the second exemplary embodiment of the present invention;

FIG. 11B illustrates an allowing portion according to the second exemplary embodiment of the present invention;

FIG. 11C illustrates a first support member according to the second exemplary embodiment of the present invention;

FIGS. 12A, 12B, 12C, and 12D illustrate the manner in which the trailing-end gripper is handed over from the first support member to a second support member according to the second exemplary embodiment of the present invention; and

FIGS. 13A and 13B illustrate the image forming apparatus according to the second exemplary embodiment of the present invention in the states in which the transfer drum is at the opposing position and the retracted position, respectively, after transportation of the sheet of recording paper is stopped in the middle of the transporting operation.

### DETAILED DESCRIPTION

### First Exemplary Embodiment

An image forming apparatus according to a first exemplary embodiment of the present invention will now be described.

### Overall Structure

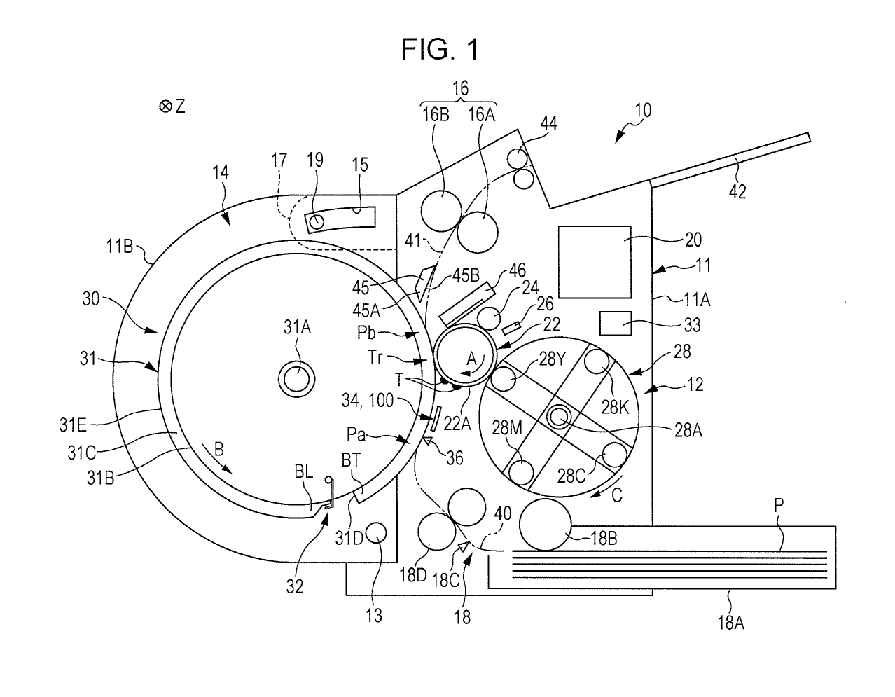

FIG. 1 illustrates an image forming apparatus 10 according to the first exemplary embodiment of the present invention. The image forming apparatus 10 includes an image forming unit 12, a paper feed unit 18, a transfer device 14, a fixing device 16, and a controller 20. The image forming unit 12 forms a toner image T, which is an example of a developer image. The paper feed unit 18 feeds and transports a sheet of recording paper P, which is an example of a recording medium. The transfer device 14 transfers the toner image T formed by the image forming unit 12 onto the sheet of recording paper P while retaining the sheet of recording paper P. The fixing device 16 fixes the toner image T to the sheet of recording paper P after the sheet of recording paper P is released from the transfer device 14. The controller 20 controls the overall operation (operation of each part) of the image forming apparatus 10. A housing 11 that forms the body of the image forming apparatus 10 houses components of the image forming apparatus 10. A paper receiver 42, which receives the sheet of recording paper P that has been ejected from the fixing device 16, is provided at the top of the housing 11.

The housing 11 includes a body portion 11A and a movable portion 11B. The body portion 11A is an example of an apparatus body in which components and parts other than a transfer drum 30, which will be described below, are disposed. The movable portion 11B supports the transfer drum 30 in a rotatable manner and is configured to be movable with respect to the body portion 11A.

At each end of the movable portion 11B in an axial direction of a rotating shaft 31A, which will be described below (hereinafter referred to as a Z direction), a semicircular side plate is provided which extends outward beyond the outer peripheral surface of the transfer drum 30 from the center of the transfer drum 30 when viewed in the Z direction. The transfer drum 30 is rotatably supported on the semicircular side plate by a bearing (not shown). A columnar connecting member 13, whose axial direction coincides with the Z direction, is attached to the movable portion 11B at a position below the transfer drum 30 and close to the body portion 11A. The movable portion 11B has an arc-shaped guide hole 15 that extends through the semicircular side plate in the Z direction at a position above the transfer drum 30. The guide hole 15 is curved from a position near the fixing device 16 toward the transfer drum 30.

At each end of the body portion 11A in the Z direction, a bearing (not shown) is provided so as to support the connecting member 13 in a rotatable manner. The body portion 11A includes a protruding portion 17 that horizontally protrudes from a position near the fixing device 16 toward a position above the transfer drum 30. An end of a columnar pin 19, whose axial direction extends in the Z direction, is fixed to the protruding portion 17. The other end of the pin 19 is inserted through the guide hole 15 in the movable portion 11B.

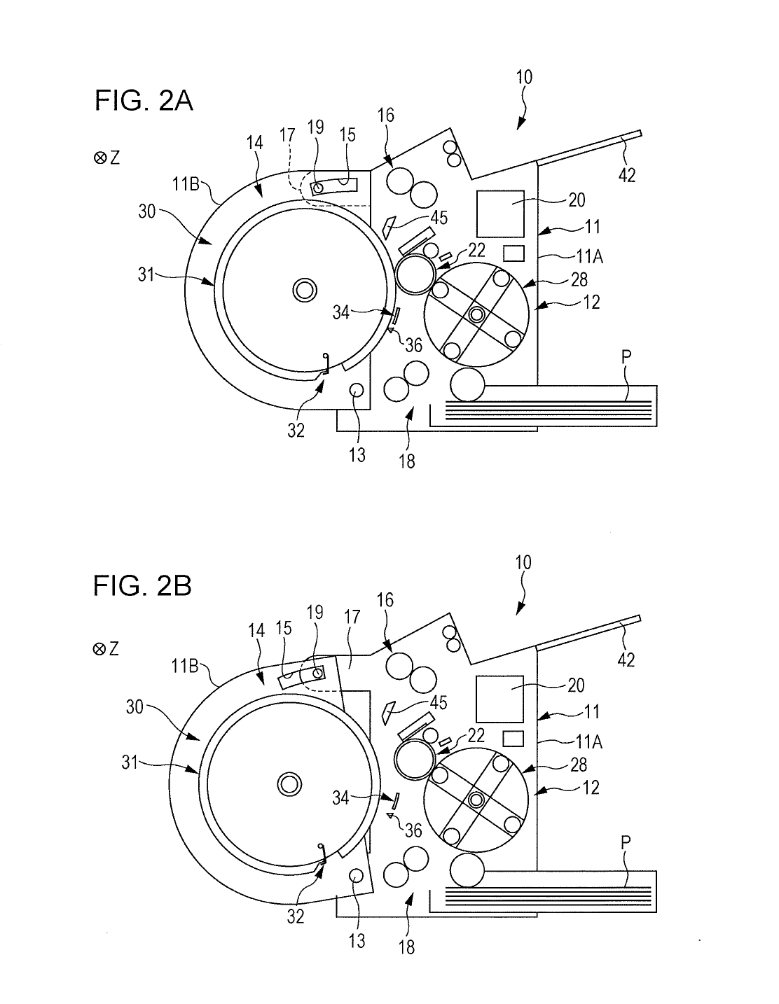

As illustrated in FIGS. 2A and 2B, when a user (not shown) pulls the movable portion 11B toward himself or herself (leftward in FIGS. 2A and 2B), the movable portion 11B moves so as to pivot about the connecting member 13. The movable portion 11B moves while the inner wall of the guide hole 15 is guided by the pin 19. When the pin 19 comes into contact with the end surface of the inner wall of the guide hole 15 that is near the fixing device 16, the movable portion 11B is caused to stop moving. The position of the transfer drum 30 in this state is referred to as a retracted position (position illustrated in FIG. 2B). The position of the transfer drum 30 in the state in which the outer peripheral surface of the transfer drum 30 is in contact with the outer peripheral surface of a photoconductor drum 22 is referred to as an opposing position (position illustrated in FIG. 2A).

As illustrated in FIG. 1, the image forming unit 12 includes the photoconductor drum 22, a charging device 24, an exposure device 26, a developing device 28, and a cleaning device 46. The photoconductor drum 22 is an example of an image carrier, and is rotatably provided in the body portion 11A. The charging device 24 charges the photoconductor drum 22. The exposure device 26 subjects the photoconductor drum 22 in the charged state to an exposure process. The developing device 28 performs a developing process by using toner (not shown), which is an example of developer. The cleaning device 46 removes the toner that remains on the photoconductor drum 22 after a transfer process from the photoconductor drum 22.

The photoconductor drum 22 includes a photosensitive layer 22A having, for example, a negative charge polarity, on the outer peripheral surface thereof. The photoconductor drum 22 may be rotated in the direction of arrow A (clockwise in FIG. 1) by a driving unit (not shown) including a motor. The outer diameter of the photoconductor drum 22 is, fore example, 30 mm. The photoconductor drum 22 is grounded. The charging device 24, the exposure device 26, the developing device 28, and the cleaning device 46 are arranged so as to face the photosensitive layer 22A (outer peripheral surface) of the photoconductor drum 22 in that order in the direction of arrow A.

The charging device 24 is, for example, a contact roller discharge device, and discharges electricity when a voltage is applied to the charging device 24 by a voltage applying unit (not shown) and a potential difference is generated between the charging device 24 and the photoconductor drum 22, which is grounded. The charging device 24 charges the photoconductor drum 22 while rotating together with the photoconductor drum 22.

The exposure device 26 forms an electrostatic latent image by irradiating the charged surface of the photoconductor drum 22 with light on the basis of image data (image information) transmitted from an image data processor (not shown). The exposure device 26 includes, for example, an array of LEDs (not shown), which serve as light sources, and distributed index lenses (not shown).

The developing device 28 is a rotary developing device that has a columnar shape. The developing device 28 includes a rotating shaft 28A, whose axial direction coincides with that of a rotating shaft (not shown) of the photoconductor drum 22, and yellow (Y), magenta (M), cyan (C), and black (K) developing units 28Y, 28M, 28C, and 28K which are arranged around the rotating shaft 28A at an angular pitch of 90°. The developing device 28 is detachably attached to the body portion 11A. The developing device 28 is configured to rotate around the rotating shaft 28A in the direction of arrow C (clockwise in FIG. 1).

In the case where only single-color images are to be formed instead of color images (multicolor images), the developing device 28 may be replaced by a developing device that includes only a developing unit for a single color (for example, only the black (K) developing unit 28K). The developing device 28 is configured such that one of the developing units 28Y, 28M, 28C, and 28K is stopped at the position where the developing device 28 faces the outer peripheral surface of the photoconductor drum 22. Thus, the developing device 28 develops the electrostatic latent image that has been formed on the photoconductor drum 22 by the exposure device 26 with toner. The outer diameter of the developing device 28 is, for example, 100 mm.

Each of the developing units 28Y, 28M, 28C, and 28K contains, for example, single-component developer (not shown) which includes only magnetic or non-magnetic toner. Although the single-component developer is used as an example in the present exemplary embodiment, two-component toner including toner and carrier may instead be used. In the following description, the single-component developer is simply referred to as developer.

The cleaning device 46 includes, for example, a blade-type cleaner and removes with a blade the developer and substances other than the developer that remain on the outer peripheral surface of the photoconductor drum 22 after the transfer process.

A feed path 40 and an output path 41 are provided in the housing 11. The feed path 40 is an example of a transport path for transporting a sheet of recording paper P from a paper container 18A, which will be described below, to a transfer region Tr. The output path 41 is used to eject the sheet of recording paper P onto which the toner image T has been transferred to the paper receiver 42 through the fixing device 16. In the present exemplary embodiment, the sheet of recording paper P that has been transported to the transfer drum 30, which will be described below, is rotated while being wrapped around the transfer drum 30 by a leading-end gripper 32 and a trailing-end gripper 34, which will be described below.

The paper feed unit 18 includes the paper container 18A and a pick-up roller 18B. The paper container 18A is disposed in a lower section of the image forming apparatus 10, more specifically, below the transfer drum 30, which will be described in detail below, and contains sheets of recording paper P. The pick-up roller 18B picks up the sheets of recording paper P from the paper container 18A. The paper feed unit 18 also includes separation rollers (not shown) that separate the sheets of recording paper P from each other, a registration sensor 18C that is provided on the feed path 40 and used to transport the sheets of recording paper P at a set timing, and transport rollers 18D that transport the sheets of recording paper P.

A paper detection sensor 36 is disposed near the feed path 40. The paper detection sensor 36 is arranged so as to face the outer peripheral surface of the transfer drum 30 with the feed path 40 provided therebetween. The paper detection sensor 36 detects passage of each sheet of recording paper P that is transported while being wrapped around the transfer drum 30. More specifically, the paper detection sensor 36 emits near-infrared light toward the outer peripheral surface of the transfer drum 30 and receives reflected light (near-infrared light) from the outer peripheral surface of the transfer drum 30 or the sheet of recording paper P retained by the transfer drum 30. The paper detection sensor 36 detects passage of the leading and trailing ends of the sheet of recording paper P in the transporting direction by detecting a change in the intensity of the reflected light.

The paper detection sensor 36 is disposed upstream of a standby position of the trailing-end gripper 34, which will be described below, in the transporting direction of the sheet of recording paper P. In the present exemplary embodiment, for example, the paper detection sensor 36 is disposed between the standby position of the trailing-end gripper 34 and a paper feed position Pa of the sheet of recording paper P, which will be described below. The paper detection sensor 36 also measures the rotational position of the transfer drum 30 that rotates by detecting marks (not shown) formed on the outer peripheral surface of an end portion of the transfer drum 30 in the axial direction.

A separating member 45 is provided at a position adjacent to the output path 41 and downstream of the transfer region Tr. The separating member 45 includes a separating portion 45A having the shape of a wedge that points toward the transfer region Tr and a flat guide portion 45B that extends along the output path 41 and guides the sheet of recording paper P. Even when the leading end of the sheet of recording paper P that has passed through the transfer region Tr tries to return to the transfer drum 30, the leading end of the sheet of recording paper P comes into contact with the separating member 45 and is guided toward the output path 41, so that the sheet of recording paper P is separated from the transfer drum 30.

The fixing device 16 is provided on the output path 41 and includes, for example, a heating roller 16A and a pressing roller 16B. The heating roller 16A is rotatable and a heat source (not shown) including, for example, a halogen lamp is disposed in the heating roller 16A. The pressing roller 16B is rotatable and has an axial direction that coincides with that of the heating roller 16A. The pressing roller 16B presses the sheet of recording paper P against the outer peripheral surface of the heating roller 16A. Paper output rollers 44 are disposed downstream of the fixing device 16 in the transporting direction of the sheet of recording paper P.

### Structure of Relevant Part

The transfer device 14 will now be described.

Referring to FIG. 1, the transfer device 14 includes the transfer drum 30, a transfer-drum driver (not shown), and a transfer-bias applying unit 33. The transfer drum 30 is an example of a recording-medium transporting member that retains the sheet of recording paper P. The transfer-drum driver (not shown) rotates the transfer drum 30. The transfer-bias applying unit 33 is an example of a transfer unit that transfers the toner image T, which is formed on the photoconductor drum 22 that faces the outer peripheral surface of the transfer drum 30, onto the sheet of recording paper P that is transported by the transfer drum 30 that is rotated by the transfer-drum driver. The transfer device 14 further includes the paper detection sensor 36, which detects passage of the sheet of recording paper P.

The transfer drum 30 includes a cylindrical portion 31, the leading-end gripper 32, and the trailing-end gripper 34. The sheet of recording paper P is wrapped around an outer peripheral surface 31E of the cylindrical portion 31. The leading-end gripper 32 is an example of a holding portion that holds a leading-end portion of the sheet of recording paper P. The trailing-end gripper 34 is an example of a retaining portion that retains a trailing-end portion of the sheet of recording paper P. The image forming apparatus 10 includes connecting structures 100, which are an example of an allowing unit that allows the transfer drum 30 to be separated from the trailing-end gripper 34 so as to avoid interference with the feed path 40. The connecting structures 100 will be described in detail below.

The outer peripheral surface 31E of the cylindrical portion 31 faces the outer peripheral surface of the photoconductor drum 22. The cylindrical portion 31 is rotatable around the rotating shaft 31A, and is detachable from (movable relative to) the body portion 11A. The cylindrical portion 31 includes a cylindrical base 31B and an elastic layer 31C that is formed on the outer peripheral surface of the base 31B. More specifically, the elastic layer 31C extends along the outer peripheral surface of the base 31B from a leading-end portion BL to a trailing-end portion BT of the elastic layer 31C in the transporting direction of the sheet of recording paper P. The cylindrical portion 31 has a cut portion 31D that is recessed in the radial direction and at which the base 31B is exposed.

The cylindrical portion 31 is configured to rotate in the direction of arrow B (counterclockwise in FIG. 1) at a peripheral speed that is slightly different from that of the photoconductor drum 22 while the elastic layer 31C is elastically deformed so as to form a nip portion between the elastic layer 31C and the photoconductor drum 22. The rotating shaft (not shown) of the photoconductor drum 22 is rotatably supported by the body portion 11A, and the rotating shaft 31A of the cylindrical portion 31 is rotatably supported by the movable portion 11B. The distance between the rotating shafts of the photoconductor drum 22 and the cylindrical portion 31 is maintained. For example, the outer diameter of the cylindrical portion 31 is greater than that of the photoconductor drum 22 and is 120 mm.

The base 31B of the cylindrical portion 31 is, for example, a conductive hollow tube made of a metal. The elastic layer 31C is a semiconductive elastic member and is made of rubber, such as polyurethane, chloroprene, ethylene propylene rubber (EPDM), or nitrile rubber (NBR). For example, the elastic layer 31C is made of polyurethane. The elastic layer 31C has no dielectric, such as a dielectric sheet, on the outer peripheral surface thereof. The peripheral length of the cylindrical portion 31 (the peripheral length of the elastic layer 31C) is greater than the maximum print length, that is, the maximum length of an image formed on the sheet of recording paper P by the image forming apparatus 10 in the transporting direction of the sheet of recording paper P.

The transfer-bias applying unit 33 applies a transfer bias, which is a voltage having a polarity opposite to that of the toner, to the base 31B. Accordingly, a potential difference is generated between the grounded photoconductor drum 22 and the transfer drum 30 (base 31B) and the toner image T on the photoconductor drum 22 is transferred onto the sheet of recording paper P on the elastic layer 31C in the transfer region Tr. The transfer region Tr is a region in which the photoconductor drum 22 and the transfer drum 30 face or oppose each other and in which the photoconductor drum 22 and the transfer drum 30 may be in contact with each other to transfer the toner image T on the photoconductor drum 22 onto the sheet of recording paper P on the elastic layer 31C.

The leading-end gripper 32 and the trailing-end gripper 34 are rotatable together with the transfer drum 30, and are configured to retain the sheet of recording paper P on the transfer drum 30. The leading-end gripper 32 and the trailing-end gripper 34 will now be described in detail.

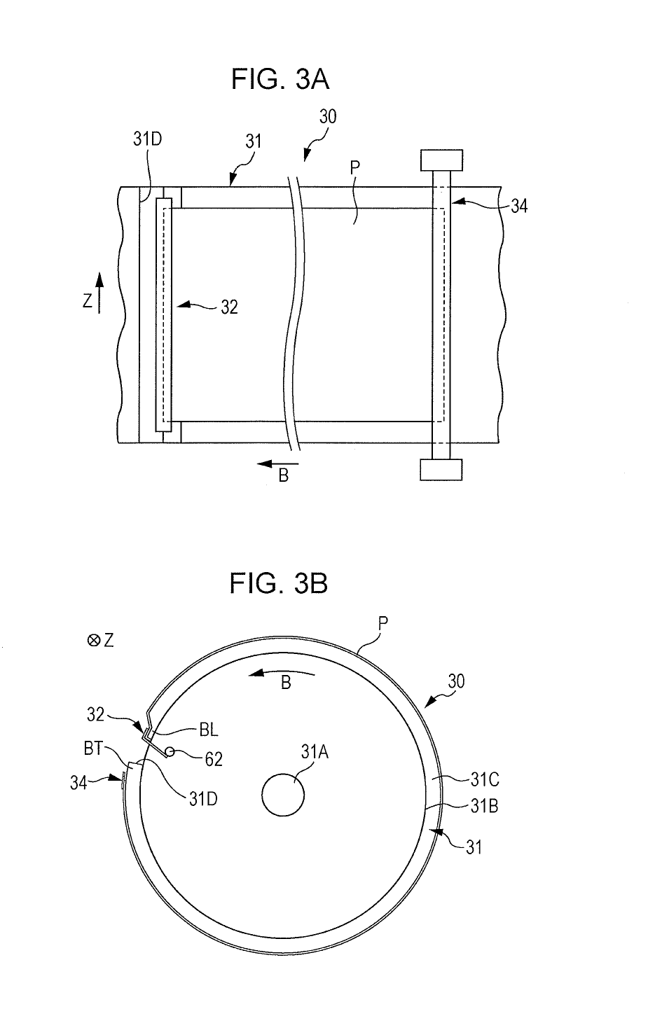

As illustrated in FIGS. 3A and 3B, the leading-end portion of the sheet of recording paper P in the transporting direction (direction of arrow B) thereof, that is, the left end portion of the sheet of recording paper P in FIG. 3A, is held by the leading-end gripper 32 on the transfer drum 30. The trailing-end portion of the sheet of recording paper P in the transporting direction thereof, that is, the right end portion of the sheet of recording paper P in FIG. 3A, is retained by the trailing-end gripper 34. The leading-end gripper 32 is fixed to the transfer drum 30.

The trailing-end gripper 34 is formed separately from the transfer drum 30, and the position of the trailing-end gripper 34 in the circumferential direction of the transfer drum 30 is changeable. The leading-end gripper 32 holds the sheet of recording paper P so as to restrain the sheet of recording paper P from being displaced in the transporting direction and from moving away from the transfer drum 30. The trailing-end gripper 34 retains the sheet of recording paper P so as to allow the sheet of recording paper P to be displaced in the transporting direction but restrain the sheet of recording paper P from moving away from the transfer drum 30. The position at which the trailing-end gripper 34 faces the outer peripheral surface of the transfer drum 30 in an area between the paper feed position Pa and the transfer region Tr (see FIG. 1) while the transfer drum 30 is stationary is referred to as an initial position (standby position). The trailing-end gripper 34 is separated from the transfer drum 30 at the initial position. Therefore, the initial position is also a separate position, which will be described below, of the trailing-end gripper 34.

### Leading-End Gripper

The leading-end gripper 32 will now be described.

As illustrated in FIG. 3B, the leading-end gripper 32 is disposed in the cut portion 31D of the transfer drum 30. One end of the leading-end gripper 32 is connected to the cylindrical portion 31. The other end of the leading-end gripper 32 moves relative to the cylindrical portion 31 so as to hold the sheet of recording paper P that enters the space between the leading-end gripper 32 and the cylindrical portion 31.

More specifically, the leading-end gripper 32 is made of, for example, a stainless steel (SUS) and is disposed between the trailing-end portion BT and the leading-end portion BL of the elastic layer 31C. The leading-end gripper 32 is configured so as not to contact the photoconductor drum 22 (see FIG. 1) irrespective of whether the leading-end gripper 32 is in the open state or closed state. The cylindrical portion 31 is provided with columnar pins 62 that project outward in the Z direction at both ends of the cylindrical portion 31 in the Z direction. The leading-end gripper 32 is supported so as to be movable (pivotable) around the pins 62.

A tension spring (not shown) is provided such that one end thereof is fixed to the cylindrical portion 31 and the other end thereof is connected to the leading-end gripper 32. The leading-end gripper 32 holds the sheet of recording paper P together with the leading-end portion BL of the elastic layer 31C by being moved toward the leading-end portion BL by the tension of the tension spring.

Although not illustrated, the leading-end gripper 32 extends toward the inside of the cylindrical portion 31 beyond the position at which the leading-end gripper 32 is connected to each pin 62. A solenoid (not shown) is provided on the extending portion of the leading-end gripper 32 at the same side as the tension spring (not shown). The solenoid operates so as to move the extending portion in a direction such that the tension spring is stretched. Thus, the leading-end gripper 32 may be maintained in the open state even when the tension of the tension is spring is applied. The leading-end gripper 32 opens toward the downstream side in the transporting direction of the sheet of recording paper P. When the solenoid returns to the original position, the leading-end gripper 32 is closed by the tension of the tension spring. Thus, the leading-end gripper 32 is opened and closed.

### Trailing-End Gripper

The trailing-end gripper 34 will now be described.

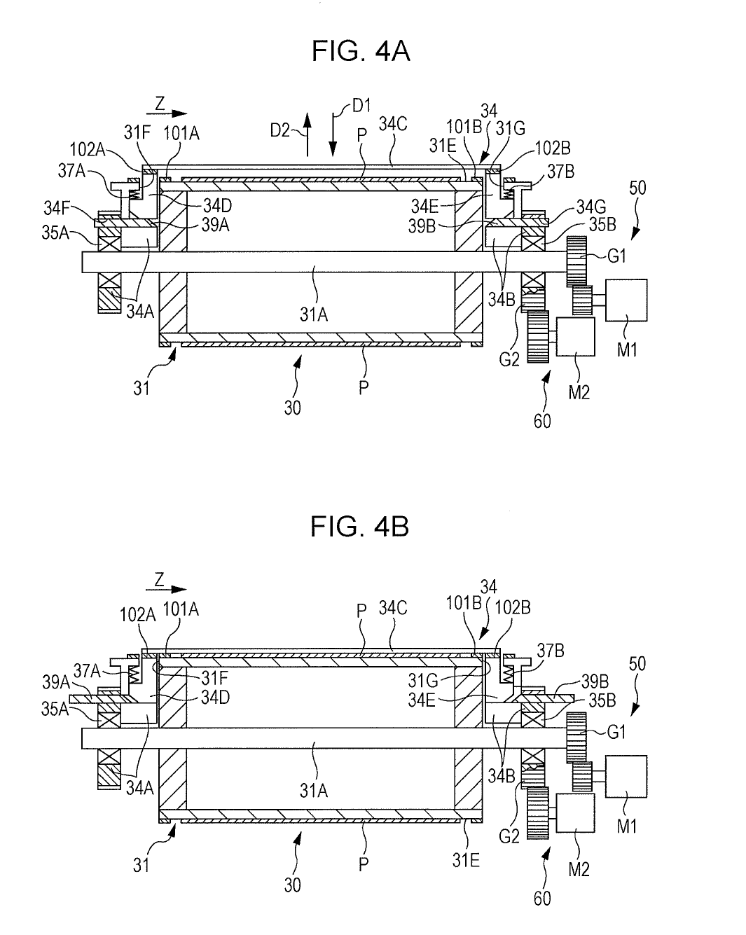

As illustrated in FIGS. 4A and 4B, the trailing-end gripper 34 is formed in an angular U-shape so as to extend over the transfer drum 30 in the Z direction. The trailing-end gripper 34 includes disc-shaped shaft portions 34A and 34B, whose axial directions coincide with the Z direction, at both ends of the trailing-end gripper 34 in the Z direction. Bearings 35A and 35B are provided on the radially inner sides of the shaft portions 34A and 34B, respectively. The rotating shaft 31A is inserted through the bearings 35A and 35B. Therefore, the trailing-end gripper 34 is rotatable around the rotating shaft 31A independently of the transfer drum 30.

The trailing-end gripper 34 includes a rectangular paper retainer 34C, annular members 101A and 101B, and connecting members 102A and 102B. The paper retainer 34C faces the outer peripheral surface 31E of the transfer drum 30 and retains the sheet of recording paper P. The annular members 101A and 101B are provided at both ends of the transfer drum 30 in the Z direction and are movable along the outer peripheral surface 31E in the circumferential direction together with the trailing-end gripper 34. The connecting members 102A and 102B are connected to the annular members 101A and 101B, respectively, at one end thereof, so that the paper retainer 34C is connected to the transfer drum 30. The connecting members 102A and 102B will be described in detail below.

The trailing-end gripper 34 further includes raising-and-lowering members 34D and 34E, pushing members 39A and 39B, and springs 37A and 37B. The raising-and-lowering members 34D and 34E are arranged on the inner sides of the connecting members 102A and 102B, respectively, in the radial direction of the transfer drum 30 and are movable in the radial direction. The pushing members 39A and 39B are used to raise and lower the raising-and-lowering members 34D and 34E, respectively. The springs 37A and 37B are disposed inside from the cylindrical portion 31 and urge the raising-and-lowering members 34D and 34E inward in the radial direction.

The paper retainer 34C extends along the rotating shaft 31A of the transfer drum 30. The length of the paper retainer 34C is greater than the maximum width of the sheet of recording paper P that may be used in the image forming apparatus 10 (see FIG. 1), that is, the dimension of the sheet of recording paper P in the Z direction in the state in which the sheet of recording paper P is wrapped around the outer peripheral surface of transfer drum 30. The paper retainer 34C comes into contact with the photoconductor drum 22 in the transfer region Tr (see FIG. 1). Therefore, preferably, the paper retainer 34C is thin and has no corner portions.

The shape of the paper retainer 34C may be, for example, a film shape, a wire shape, or a columnar shape. The paper retainer 34C is made of a resin, such as polyethylene terephthalate (PET), polyimide, or fluorocarbon resin. Here, for example, the paper retainer 34C is made of polyimide.

The raising-and-lowering members 34D and 34E face each other with a gap therebetween, the gap being larger than the maximum width of the sheet of recording paper P that may be used in the image forming apparatus 10 (see FIG. 1). The raising-and-lowering members 34D and 34E extend in the radial direction of the transfer drum 30. The raising-and-lowering members 34D and 34E are disposed in through holes 31F and 31G, respectively, that extend through the cylindrical portion 31 in the radial direction. The raising-and-lowering members 34D and 34E respectively push the connecting members 102A and 102B upward by moving outward in the radial direction of the rotating shaft 31A and lower the connecting members 102A and 102B by moving inward in the radial direction of the rotating shaft 31A.

The pushing members 39A and 39B are plate-shaped members that are respectively inserted through holes 34F and 34G formed in the shaft portions 34A and 34B, respectively so as to extend therethrough in the Z direction. The pushing members 39A and 39B are rotatable around the rotating shaft 31A together with the raising-and-lowering members 34D and 34E. The pushing members 39A and 39B may be moved in the Z direction by operating solenoids (not shown). The raising-and-lowering members 34D and 34E are moved in the radial direction of the transfer drum 30 when the pushing members 39A and 39B are moved in the Z direction (in the opposite directions). The raising-and-lowering members 34D and 34E and the pushing members 39A and 39B have end faces that are inclined (tapered) with respect to a horizontal or vertical plane at an angle of 45°, and are arranged such that the end faces contact each other.

As illustrated in FIG. 4A, when the pushing members 39A and 39B are moved toward the transfer drum 30 in the Z direction, the raising-and-lowering members 34D and 34E, which are respectively in contact with the pushing members 39A and 39B, are moved upward and outward in the radial direction of the cylindrical portion 31. Accordingly, the connecting members 102A and 102B are pushed upward and outward in the radial direction of the cylindrical portion 31, so that the gap between the paper retainer 34C and the outer peripheral surface 31E is increased so as to form an opening. The position of the trailing-end gripper 34 in this state is referred to as the separate position.

As illustrated in FIG. 4B, when the pushing members 39A and 39B are moved away from the transfer drum 30, the raising-and-lowering members 34D and 34E are moved downward and inward in the radial direction of the cylindrical portion 31. Accordingly, the connecting members 102A and 102B are moved downward, that is, inward in the radial direction of the cylindrical portion 31, so that the gap between the paper retainer 34C and the outer peripheral surface 31E is reduced and the sheet of recording paper P that is wrapped around the outer peripheral surface 31E is retained by the paper retainer 34C. The position of the trailing-end gripper 34 in this state is referred to as the retaining position.

As illustrated in FIGS. 4A and 4B, the transfer drum 30 is rotated by a transfer-drum driver 50. The transfer-drum driver 50 includes a transfer-drum motor M1 that rotates the transfer drum 30 and a transfer-drum gear G1 that is connected to an end of the rotating shaft 31A and receives a driving force from the transfer-drum motor M1.

The trailing-end gripper 34 is rotated by a trailing-end-gripper driver 60. The trailing-end-gripper driver 60 includes a trailing-end-gripper motor M2 that rotates the shaft portion 34B of the trailing-end gripper 34 and a shaft-portion gear G2 that is provided on the outer peripheral surface of the shaft portion 34B and receives a driving force from the trailing-end-gripper motor M2.

### Connecting Structures

The connecting structures 100 will now be described.

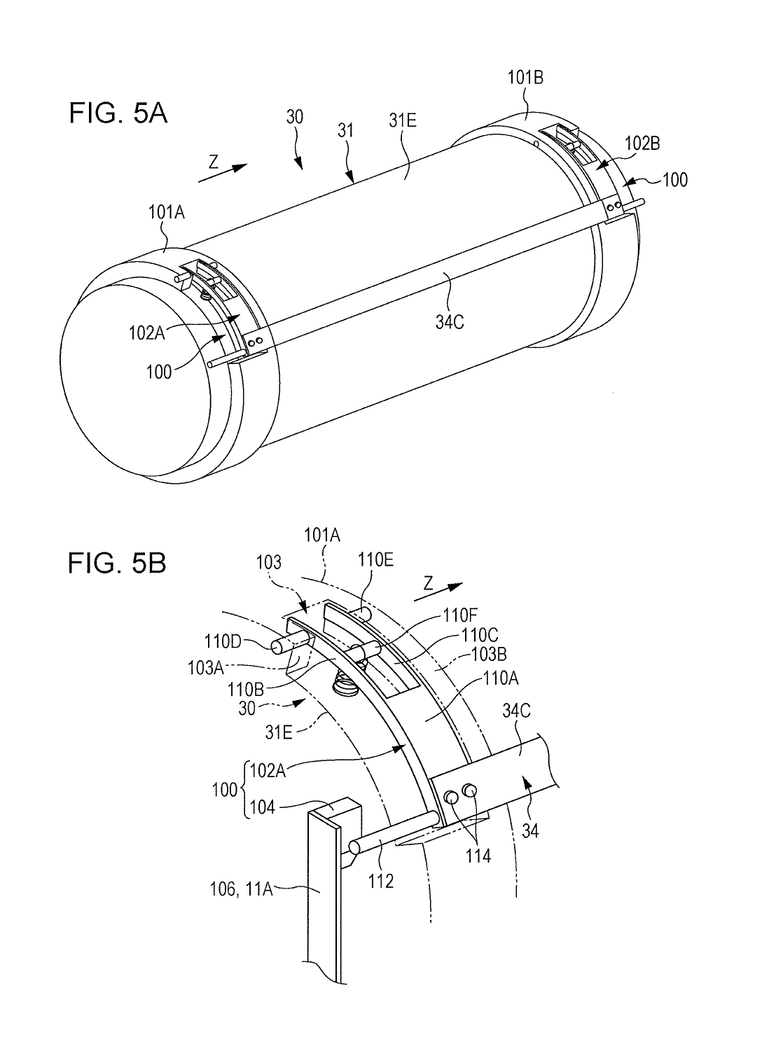

As illustrated in FIG. 5A, the connecting structures 100 are provided at both ends of the transfer drum 30 in the positive and negative Z directions. The connecting structures 100 at the ends in the positive and negative Z directions are symmetrical to each other and have a similar structure. Therefore, only the connecting structure 100 at the end in the negative Z direction will be described and explanation of the connecting structure 100 at the end in the positive Z direction will be omitted.

As illustrated in FIG. 5B, the connecting structure 100 includes the connecting member 102A and a regulating member 104. The connecting member 102A supports the trailing-end gripper 34 such that the trailing-end gripper 34 is movable with respect to the transfer drum 30. The regulating member 104 is provided on a plate-shaped bracket 106 that forms a part of the body portion 11A, and is configured to regulate the movement of the trailing-end gripper 34.

The connecting member 102A includes an attachment portion 110A that extends along the outer peripheral surface 31E of the transfer drum 30 when transferring of the toner image T (see FIG. 1) is performed. The attachment portion 110A is arc shaped and has a uniform thickness in the circumferential direction of the transfer drum 30. The attachment portion 110A is formed integrally with arm portions 110B and 110C at an end thereof in the circumferential direction. The arm portions 110B and 110C face each other with a gap therebetween in the Z direction and extend in the circumferential direction. A columnar pin 110D projects in the negative Z direction from the negative-Z-direction side surface of the arm portion 110B. A columnar pin 110E projects in the positive Z direction from the positive-Z-direction side surface of the arm portion 110C.

A connecting pin 110F that connects the arm portions 110B and 110C to each other in the Z direction is provided between the arm portions 110B and 110C. An end of a columnar contact portion 112 is attached to the negative-Z-direction side surface of the attachment portion 110A at an end opposite to the end at which the arm portions 110B and 110C are provided. The contact portion 112 has an axial direction that coincides with the Z direction and projects from the attachment portion 110A in the negative Z direction. An end portion of the paper retainer 34C in the negative Z direction is fixed (connected) to the attachment portion 110A with screws 114.

The annular member 101A has a cut portion 103 that is large enough to accommodate the connecting member 102A. The cut portion 103 is formed in a part of the annular member 101A in the circumferential direction. The cut portion 103 formed in the annular member 101A has walls 103A and 103B that extend in the circumferential direction and face each other with a gap therebetween in the Z direction. Pins 110D and 110E are rotatably attached to the walls 103A and 103B, respectively. Thus, a first end of the connecting member 102A is connected to an end portion of the transfer drum 30 in the axial direction, and a second end of the connecting member 102A is connected to the trailing-end gripper 34 (the paper retainer 34C).

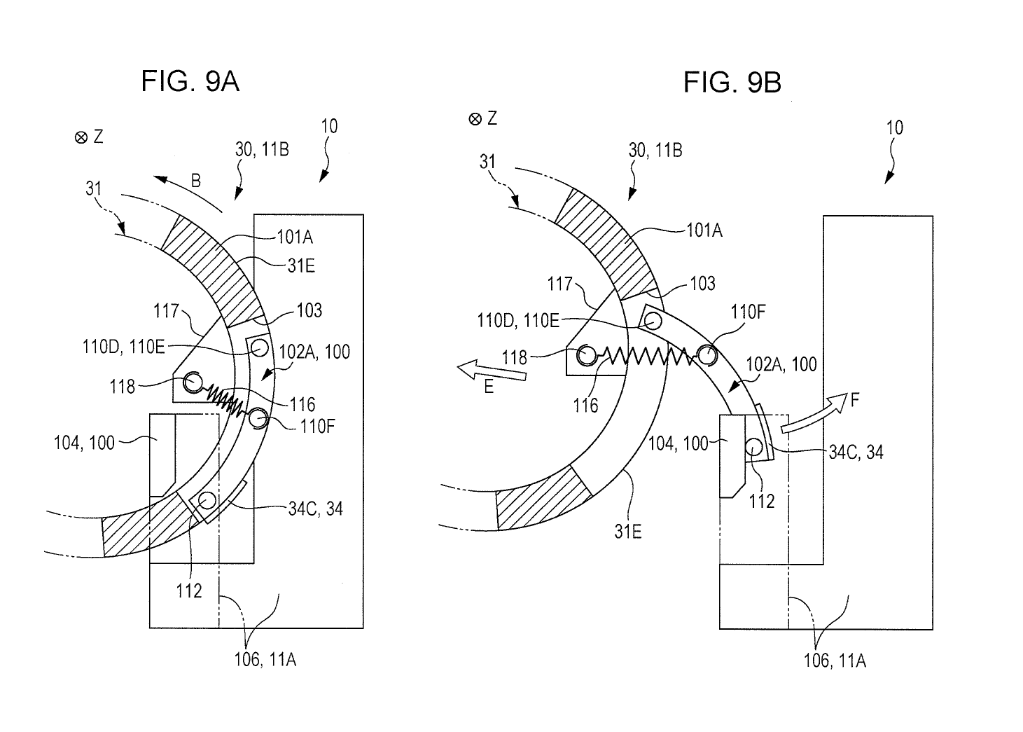

Referring to FIG. 9A, an end of a tension spring 116 is attached to the connecting pin 110F on the connecting member 102A. The other end of the tension spring 116 is engaged with a projection 118 that projects in the negative Z direction from a protruding portion 117 that protrudes toward the inside of the cylindrical portion 31. Accordingly, the second end of the connecting member 102A, which is connected to the paper retainer 34C, is pulled toward the inside of the cylindrical portion 31 and contacts a stopper (not shown) provided in the cut portion 103. Thus, the connecting member 102A is accommodated in the cut portion 103.

As illustrated in FIG. 5B, the regulating member 104 is formed of, for example, a rubber block and is positioned near the contact portion 112 and closer to the transfer drum 30 than the contact portion 112. When the transfer drum 30 is moved from the opposing position to the retracted position, the contact portion 112 of the connecting member 102A comes into contact with the regulating member 104. The regulating member 104 and the contact portion 112 are arranged so as not to come into contact with each other when the transfer drum 30 rotates.

### Image Forming Operation Performed by Image Forming Apparatus 10

An image forming operation performed by the image forming apparatus 10 (see FIG. 1) will now be described. As an example, a case will be described in which the image forming apparatus 10 forms a multicolor image on a single sheet of recording paper P.

In the image forming apparatus 10 illustrated in FIG. 1, a color reflected light image of a document read by a document reading device (not shown) or color image data generated by a personal computer (not shown) is input to an image signal processor (not shown) as, for example, red (R), green (G), and blue (B) image data and is subjected to predetermined image processing. The image data that has been subjected to image processing is converted into color gradation data of four colors, which are yellow (Y), magenta (M), cyan (C), and black (K), and is output to the exposure device 26.

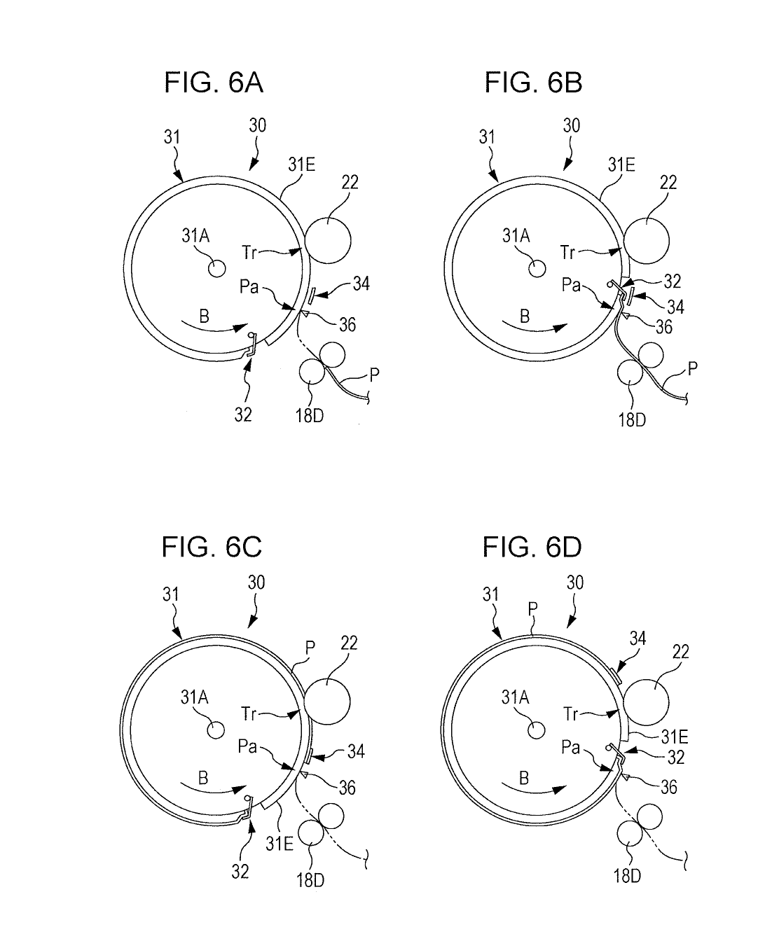

When the image forming operation is started, the photoconductor drum 22 and the transfer drum 30 rotate in synchronization with each other, more specifically, such that the transfer drum 30 rotates at a peripheral speed that is slightly different from that of the photoconductor drum 22. At this time, the leading-end gripper 32 and the trailing-end gripper 34 are both in the open state. The leading-end gripper 32 rotates together with the transfer drum 30. The trailing-end gripper 34 is stationary at the initial position and does not rotate together with the transfer drum 30. In other words, the peripheral speed of the trailing-end gripper 34 is zero. More specifically, referring to FIG. 6A, the trailing-end gripper 34 is arranged so as to face the outer peripheral surface of the transfer drum 30 at a position between the paper feed position Pa and the transfer region Tr.

Next, referring to FIG. 1, the photosensitive layer 22A of the photoconductor drum 22 that rotates is charged by the charging device 24, and the exposure device 26 irradiates the photoconductor drum 22 with light so that an electrostatic latent image of the first color (for example, yellow) that corresponds to the image information is formed. When the transfer drum 30 starts to rotate, the paper detection sensor 36 starts measuring the rotational position of the transfer drum 30. The measured rotational position is transmitted to the controller 20.

In the developing device 28, the developing unit containing color toner that corresponds to the electrostatic latent image formed on the photoconductor drum 22 (the yellow developing unit 28Y when the first color is yellow) is moved to and stopped at the position at which the developing unit faces the photoconductor drum 22 in advance. The developing unit 28Y develops the electrostatic latent image on the photoconductor drum 22, so that the toner image T is formed on the photoconductor drum 22. The toner image T (yellow toner image in this case) is transported to the transfer region Tr, in which the photoconductor drum 22 faces the transfer device 14, as the photoconductor drum 22 rotates.

When the image forming operation is started, feeding of the sheet of recording paper P is also started. More specifically, the sheet of recording paper P is picked up from the paper container 18A by the pick-up roller 18B, and is transported along the feed path 40 by the transport rollers 18D. When the paper detection sensor 36 detects passage of the leading end of the sheet of recording paper P in the transporting direction, the paper detection sensor 36 outputs a detection signal to the controller 20. Upon receiving the detection signal, the controller 20 controls, on the basis of the detection signal and phase obtained by the paper detection sensor 36, the transportation of the sheet of recording paper P so that the sheet of recording paper P reaches the paper feed position Pa at the time when the leading-end gripper 32 reaches the paper feed position Pa.

Then, as illustrated in FIG. 6B, the state of the leading-end gripper 32 is changed from the open state to the closed state at the paper feed position Pa. As a result, the leading end portion of the sheet of recording paper P in the transporting direction is held by the leading-end gripper 32. At this time, the trailing-end gripper 34 is arranged so as to face the outer peripheral surface of the transfer drum 30 and is stationary at the standby position. The leading-end gripper 32 that holds the sheet of recording paper P passes through the space between the trailing-end gripper 34 in the stationary state and the rotating shaft 31A of the transfer drum 30.

After passing through the space between the trailing-end gripper 34 and the rotating shaft 31A, the leading-end gripper 32 passes through the transfer region Tr while holding the sheet of recording paper P. The sheet of recording paper P that has passed through the transfer region Tr is transported while being held by the leading-end gripper 32 and wrapped around the outer peripheral surface 31E of the transfer drum 30.

Subsequently, referring to FIG. 1, the paper detection sensor 36 detects passage of the trailing end of the sheet of recording paper P in the transporting direction after the electrostatic latent image of the first color (for example, yellow) that corresponds to the image information is formed on the photoconductor drum 22 by the exposure device 26. The paper detection sensor 36 transmits a detection signal to the controller 20, which then transmits an instruction to the trailing-end gripper 34. Upon receiving the instruction, the trailing-end gripper 34 changes the state thereof from the open state to the closed state (see arrow D1 in FIG. 4A).

Then, as illustrated in FIG. 6C, the trailing-end gripper 34 in the closed state starts to rotate in synchronization with the transfer drum 30. In other words, the sheet of recording paper P rotates together with the transfer drum 30 while the leading end portion thereof in the transporting direction is held by the leading-end gripper 32 and the trailing end portion thereof in the transporting direction is retained by the trailing-end gripper 34. The toner image of the first color (for example, yellow) formed on the photoconductor drum 22 is transferred onto the sheet of recording paper P on the transfer drum 30 in the transfer region Tr in which the photoconductor drum 22 and the transfer drum 30 face each other. The toner that remains on the photoconductor drum 22 after the transfer process is removed by the cleaning device 46 (see FIG. 1).

Subsequently, the latent-image forming process, the developing process, and the transfer process for the second color to the second-from-last color (for example, for magenta and cyan in that order) are performed in accordance with the above-described sequence. In the process of forming the toner image T of each color, the developing device 28 (see FIG. 1) is rotated so as to move the corresponding developing unit 28M or 28C (see FIG. 1) to the stop position. Meanwhile, as illustrated in FIG. 6D, the sheet of recording paper P is rotated and transported while being wrapped around the transfer drum 30 by the leading-end gripper 32 and the trailing-end gripper 34. Each time the sheet of recording paper P passes through the transfer region Tr, the toner image of one of the second and the following colors is transferred onto the sheet of recording paper P in a superimposed manner. As a result, the toner images of colors other than black (K), that is, yellow (Y), magenta (M), and cyan (C) toner images, are transferred onto the sheet of recording paper P on the transfer drum 30 in a superimposed manner.

When the toner image T of the last color (for example, black) is transferred, unlike the process of transferring the toner images of the other colors, the state of the leading-end gripper 32 is changed from the closed state to the open state after the sheet of recording paper P has passed through the transfer region Tr. Accordingly, the sheet of recording paper P is released from the leading-end gripper 32. Then, referring to FIG. 1, the leading end of the sheet of recording paper P, on which a color image has been formed, in the transporting direction is separated from the transfer drum 30 by the separating member 45 and is guided into the output path 41 from a paper release position Pb.

Subsequently, as the sheet of recording paper P is further transported, the trailing-end gripper 34, which retains the trailing end of the sheet of recording paper P in the transporting direction, changes the state thereof from the closed state to the open state (see arrow D2 in FIG. 4A). The trailing-end gripper 34 changes the state thereof from the closed state to the open state while or after the electrostatic latent image of the last color (for example, black) that corresponds to the image information is formed by the exposure device 26. The trailing-end gripper 34 in the open state stops at the standby position.

Subsequently, the trailing end of the sheet of recording paper P in the transporting direction, which has been released from the trailing-end gripper 34, is separated from the transfer drum 30 by the separating member 45 and is guided into the output path 41 from the paper release position Pb. The sheet of recording paper P that has been guided into the output path 41 is transported to the fixing device 16, where the toner images T are fixed by the heating roller 16A and the pressing roller 16B. After the fixing process, the sheet of recording paper P is discharged to the outside of the image forming apparatus 10 by the paper output rollers 44 and is placed on the paper receiver 42.

In the case where a single-color image (for example, black (monochrome) image) is to be formed on a single sheet of recording paper P by the image forming apparatus 10, the toner image T (see FIG. 1) is transferred onto the sheet of recording paper P while the sheet of recording paper P is transported without being wrapped around the outer peripheral surface of the transfer drum 30.

### Operation

The operation of the first exemplary embodiment will now be described.

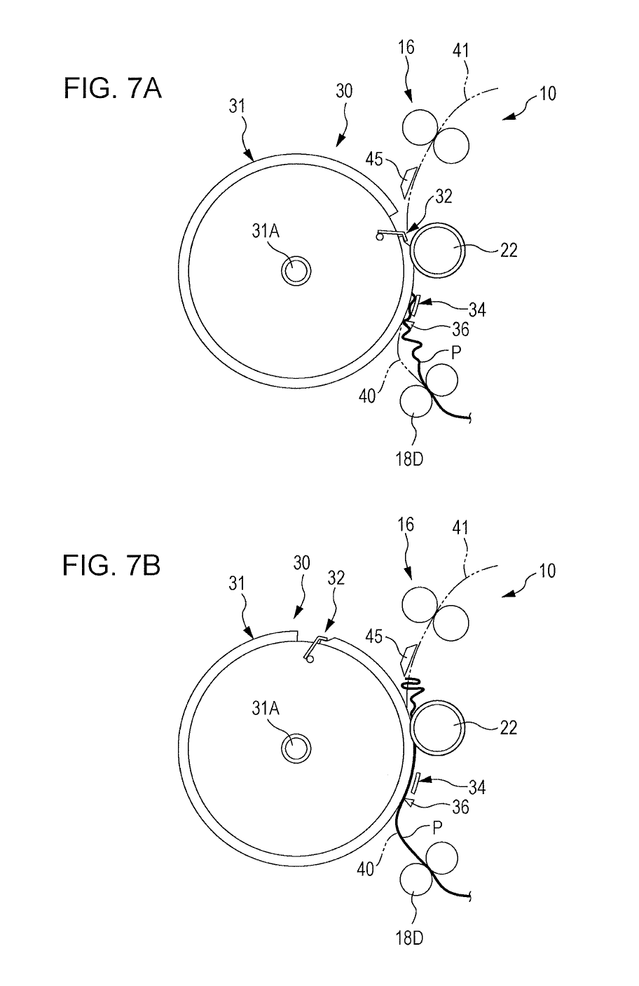

Referring to FIG. 7A, when the sheet of recording paper P is transported along the feed path 40 in the image forming apparatus 10, there is a possibility that a so-called transfer jam will occur, in which case transportation of the sheet of recording paper P will be stopped. Transfer jams occur when, for example, the leading-end gripper 32 fails to hold the leading end of the sheet of recording paper P or the leading end of the sheet of recording paper P is caught by the trailing-end gripper 34.

In addition, referring to FIG. 7B, when the sheet of recording paper P is transported along the feed path 40 in the image forming apparatus 10 in the operation of forming a monochrome (single-color) image, there is a possibility that a so-called separation jam will occur, in which case transportation of the sheet of recording paper P will be stopped. Separation jams occur when the leading end of the sheet of recording paper P is caught by the separating member 45 after the toner image is transferred. The paper detection sensor 36 (see FIG. 1) is not illustrated in FIGS. 7A and 7B.

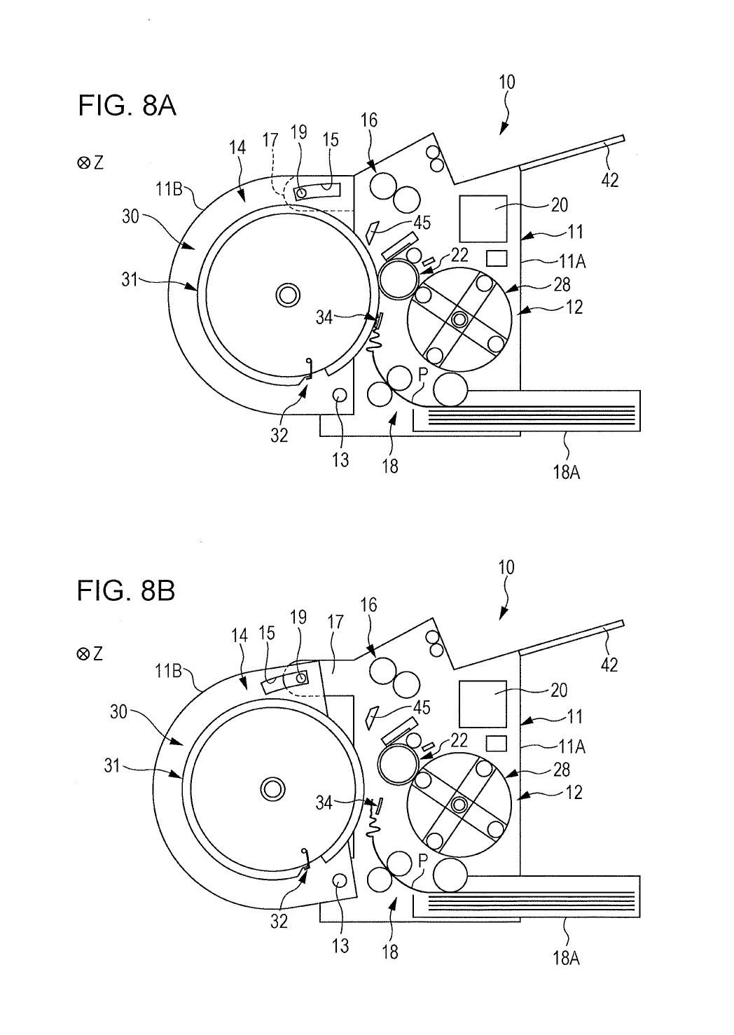

When a transfer jam occurs as an example of a jam of the sheet of recording paper P, as illustrated in FIG. 8A, the image forming apparatus 10 stops while the sheet of recording paper P is placed between the trailing-end gripper 34 at the separate position and the cylindrical portion 31. In this state, as illustrated in FIG. 9A, the contact portion 112 is not in contact with the regulating member 104.

Subsequently, as illustrated in FIG. 8B, when a user (not shown) pulls an upper part of the movable portion 11B toward himself or herself (leftward in FIG. 8B), the movable portion 11B moves so as to pivot about the connecting member 13. At this time, as illustrated in FIG. 9B, the contact portion 112 comes into contact with the regulating member 104. Since the regulating member 104 is fixed to the body portion 11A, the contact portion 112 and the trailing-end gripper 34 are caused to stop moving and stay at that position.

In contrast, the transfer drum 30 is rotatably provided in the movable portion 11B, and therefore moves together with the movable portion 11B. Thus, the second end of the connecting member 102A is moved relative to the transfer drum 30 and the gap between the outer peripheral surface 31E of the transfer drum 30 and the trailing-end gripper 34 is increased.

Thus, the connecting structures 100 allow the transfer drum 30 to be separated from the trailing-end gripper 34 so that the gap between the transfer drum 30 and the trailing-end gripper 34 is increased from the original gap (gap in the normal image forming operation). Therefore, the jammed sheet of recording paper P may be easily taken out from the image forming apparatus 10. Since it is not necessary to pull out the sheet of recording paper P with a large force, the paper retainer 34C of the trailing-end gripper 34 may be prevented from being damaged. Although a transfer jam has been explained as an example, this also applies to the case of a separation jam.

As illustrated in FIGS. 9A and 9B, in the image forming apparatus 10, the transfer drum 30 may be moved relative to the trailing-end gripper 34 with a simple structure by causing the contact portion 112 of the movable portion 11B to come into contact with the regulating member 104 of the body portion 11A.

### Second Exemplary Embodiment

Next, an image forming apparatus according to a second exemplary embodiment of the present invention will now be described. Components and parts that are basically the same as those of the first exemplary embodiment are denoted by the same reference numerals as those in the first exemplary embodiment, and explanations thereof are thus omitted.

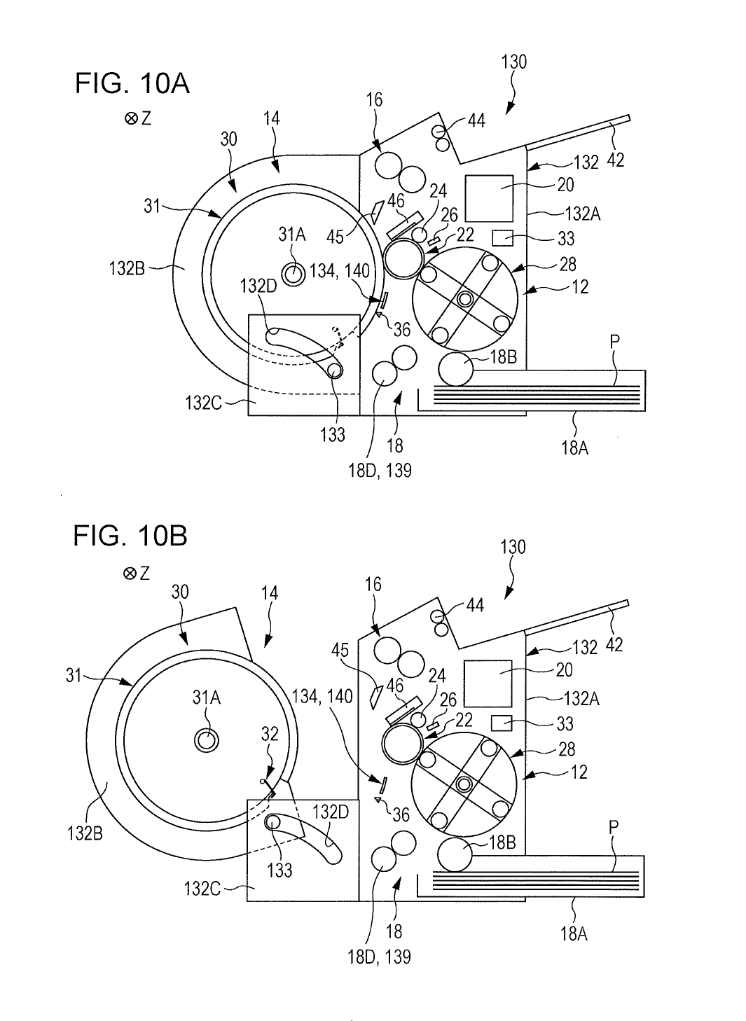

FIGS. 10A and 10B illustrate an image forming apparatus 130 according to the second exemplary embodiment. The image forming apparatus 130 differs from the image forming apparatus 10 according to the first exemplary embodiment (see FIG. 1) in that the image forming apparatus 130 includes a housing 132, a trailing-end gripper 134, and handover structures 140 in place of the housing 11, the trailing-end gripper 34, and the connecting structures 100. The housing 132 forms the body of the image forming apparatus 130. The trailing-end gripper 134 is an example of a retaining portion that retains the trailing end of the sheet of recording paper P. The handover structures 140 are an example of an allowing unit that allows the transfer drum 30 to separate from the trailing-end gripper 134. Parts other than the housing 132, the trailing-end gripper 134, and the handover structures 140 are similar to those of the image forming apparatus 10, and explanations thereof are thus omitted.

The housing 132 includes a body portion 132A and a movable portion 132B. The body portion 132A is an example of an apparatus body in which components and parts other than the transfer drum 30 are disposed. The movable portion 132B supports the transfer drum 30 in a rotatable manner and is configured to be movable with respect to the body portion 132A.

At each end of the movable portion 132B in the Z direction, a semicircular side plate is provided which extends outward beyond the outer peripheral surface of the transfer drum 30 from the center of the transfer drum 30 when viewed in the Z direction. The transfer drum 30 is rotatably supported on the semicircular side plate by a bearing (not shown). A columnar connecting member 133, whose axial direction coincides with the Z direction, is attached to the movable portion 132B at a position below the transfer drum 30 and close to the body portion 132A.

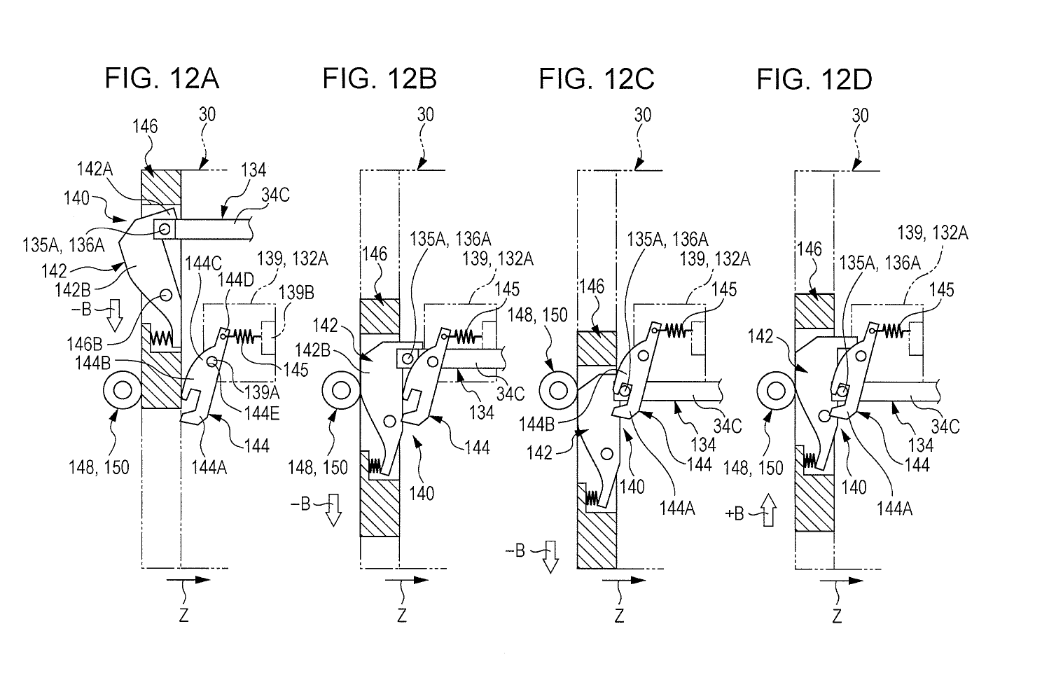

At each end of the body portion 132A in the Z direction, an apparatus frame 139 is provided, which is an example of a support on which the transport rollers 18D are rotatably supported. The transport rollers 18D are an example of a transport member that transports the sheet of recording paper P to between the photoconductor drum 22 and the transfer drum 30. As illustrated in FIG. 12A, a second support member 144, which will be described below, is provided on the apparatus frame 139.

As illustrated in FIGS. 10A and 10B, the body portion 132A is provided with a support wall 132C that stands upright at a position outside each end of the transfer drum 30 in the Z direction. The support wall 132C has a guide hole 132D that is arc-shape in a plane that crosses the Z direction and extends through the support wall 132C in the Z direction. The connecting member 133 provided on the movable portion 132B is inserted through the guide hole 132D.

When a user (not shown) pulls the movable portion 132B toward himself or herself (leftward in FIGS. 10A and 10B), a link member (not shown) allows the connecting member 133 to move along the guide hole 132D, so that the movable portion 132B is moved. When the connecting member 133 comes into contact with the end surface of the inner wall of the guide hole 132D that is far from the body portion 132A, the movable portion 132B is caused to stop moving. The position of the transfer drum 30 in this state is referred to as a retracted position (position illustrated in FIG. 10B). The position of the transfer drum 30 in the state in which the outer peripheral surface of the transfer drum 30 is in contact with the outer peripheral surface of the photoconductor drum 22 is referred to as an opposing position (position illustrated in FIG. 10A).

### Trailing-End Gripper

The trailing-end gripper 134 will now be described.

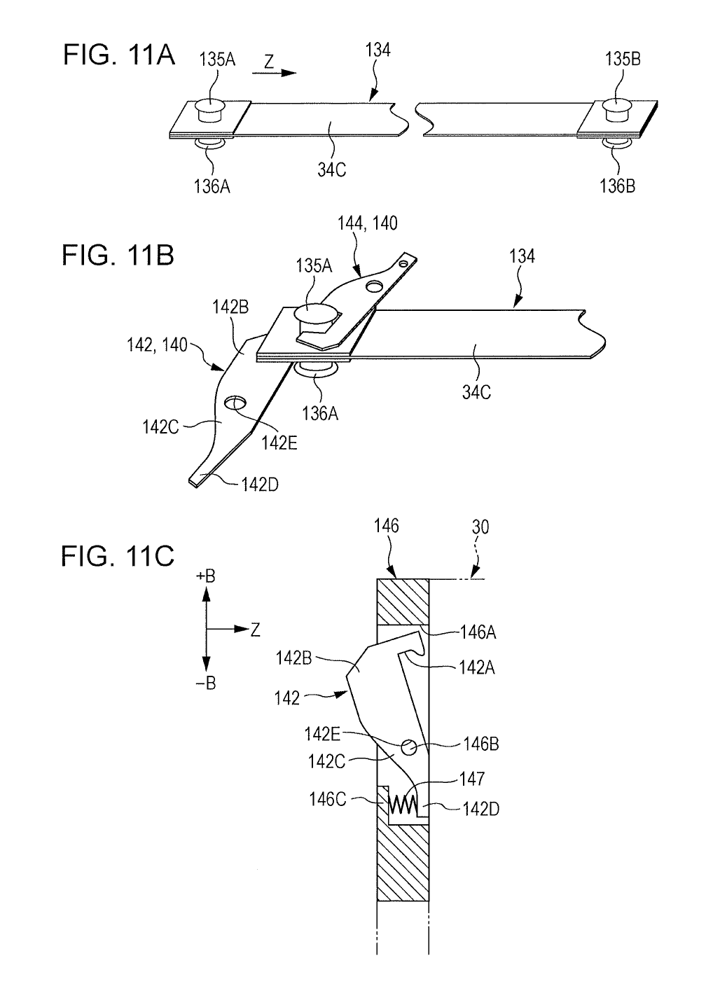

As illustrated in FIG. 11A, the trailing-end gripper 134 includes the rectangular paper retainer 34C, second projections 135A and 135B, and first projections 136A and 136B. The paper retainer 34C retains the sheet of recording paper P (not shown). The second projections 135A and 135B project from the front side (outer side in the radial direction of the transfer drum 30 (see FIG. 10A)) of the paper retainer 34C at the ends thereof in the Z direction. The first projections 136A and 136B project from the paper holder 34C at the side opposite to the second projections 135A and 135B (back surface or radially inner surface of the paper retainer 34C).

The second projections 135A and 135B and the first projections 136A and 136B have a columnar shape and include flange-shaped retainer portions that expand radially outward at the ends thereof. Portions of the trailing-end gripper 134 at the ends thereof (ends in the positive and negative Z directions) are symmetrical to each other. Therefore, only the portion at the end in the negative Z direction will be described and explanation of the portion at the end in the positive Z direction will be omitted.

As illustrated in FIG. 11B, the first projection 136A of the trailing-end gripper 134 is configured to be engageable with a first support member 142, which will be described below, and the second projection 135A of the trailing-end gripper 134 is configured to be engageable with the second support member 144, which will be described below. The first and second support members 142 and 144 are examples of first and second support portions, respectively.

As illustrated in FIG. 11C, an annular member 146 is provided at each end of the transfer drum 30 in the Z direction. The annular member 146 has a structure similar to that of the annular members 101A and 101B according to the first exemplary embodiment, and a cut portion 146A is formed in a part of the annular member 146 in the circumferential direction. The first support member 142 is disposed in the cut portion 146A. The annular members 146 at the ends of the transfer drum 30 in the positive and negative Z directions are attached to the shaft portions 34A and 34B (see FIG. 4A) according to the first exemplary embodiment, and may be rotated together with the trailing-end gripper 134 by the trailing-end-gripper driver 60 (see FIG. 4A).

In the present exemplary embodiment, a contact member 148 (see FIG. 12A), which will be described below, comes into contact with the first support member 142 (pushes the first support member 142 by an amount smaller than that in the process of handing over the trailing-end gripper 134). Accordingly, the tension applied to the trailing-end gripper 134 in the Z direction is reduced and the trailing-end gripper 134 is disposed at the separate position. When the first support member 142 is separated from the contact member 148, the tension applied to the trailing-end gripper 134 in the Z direction is increased and the trailing-end gripper 134 is disposed at the retaining position.

### Handover Structure

The handover structures 140 will now be described.

As illustrated in FIG. 12A, the handover structures 140 are provided at both ends of the transfer drum 30 in the positive and negative Z directions. The handover structures 140 at the ends in the positive and negative Z directions are symmetrical to each other and have a similar structure. Therefore, only the handover structure 140 at the end in the negative Z direction will be described and explanation of the handover structure 140 at the end in the positive Z direction will be omitted. In the following description, the direction in which the transfer drum 30 is rotated when the sheet of recording paper P is transported is referred to as a +B direction, and the direction opposite to the +B direction is referred to as a −B direction.

The handover structure 140 includes the first support member 142 provided on the transfer drum 30, the second support member 144 provided on the body portion 132A, and a handover portion 150. The handover portion 150 is an example of a handover unit that allows the trailing-end gripper 134 to be handed over from the first support member 142 to the second support member 144 and from the second support member 144 to the first support member 142.

As illustrated in FIG. 11C, the first support member 142 is rotatable around a pin 146B that projects radially outward in the cut portion 146A. The first support member 142 includes a first engagement portion 142A, a wide portion 142B, a connecting portion 142C, and an urged portion 142D, which are integrated together, in that order in the −B direction.

The first engagement portion 142A is J-shaped in plan view and opens in the −B direction. The opening width of the first engagement portion 142A is set such that each of the first projections 136A and 136B (see FIG. 11A) is engageable with and releasable from the first engagement portion 142A. The wide portion 142B, which is wide in the Z direction, continues from the end of the first engagement portion 142A and extends in the −B direction.

The connecting portion 142C continues from the end of the wide portion 142B in the −B direction. The width of the connecting portion 142C in the Z direction gradually decreases toward the end thereof in the −B direction. The connecting portion 142C has a through hole 142E that extends therethrough in the radial direction. The pin 146B is inserted through the through hole 142E. The urged portion 142D extends in the −B direction from the end of the connecting portion 142C in the −B direction.

A wall portion 146C is formed at the end of the cut portion 146A of the annular member 146 in the −B direction. The wall portion 146C extends in the +B direction at the end of the cut portion 146A in the negative Z direction. The wall portion 146C is arranged so as to face the urged portion 142D. One end of a compression spring 147 is attached to the wall portion 146C, and the other end of the compression spring 147 is attached to the urged portion 142D. Thus, the urged portion 142D is urged by the compression spring 147 in the Z direction, and the wide portion 142B projects from the cut portion 146A in the negative Z direction. The size and shape of the urged portion 142D are set such that the urged portion 142D does not project from the cut portion 146A in the Z direction in the state in which the wide portion 142B projects from the annular member 146.

As illustrated in FIG. 12A, the second support member 144 is rotatable around a pin 139A that projects from the apparatus frame 139 in the radial direction. The second support member 144 includes a second engagement portion 144A, a wide portion 144B, a connecting portion 144C, and an attachment portion 144D, which are integrated together, in that order in the −B direction.

The second engagement portion 144A is J-shaped in plan view and opens in the negative Z direction. The opening width of the second engagement portion 144A is set such that each of the second projections 135A and 135B (see FIG. 11A) is engageable with and releasable from the second engagement portion 144A. The wide portion 144B, which is wide in the Z direction, continues from an end of the second engagement portion 144A and extends in the +B direction (see FIG. 11C).

The connecting portion 144C continues from the end of the wide portion 144B in the +B direction. The width of the connecting portion 144C in the Z direction gradually decreases toward the end thereof in the +B direction. The connecting portion 144C has a through hole 144E that extends therethrough in the radial direction. The pin 139A is inserted through the through hole 144E. The attachment portion 144D extends in the +B direction from the end of the connecting portion 144C in the +B direction.

A wall portion 139B is formed on the apparatus frame 139 so as to face the attachment portion 144D. One end of a tension spring 145 is attached to the wall portion 139B, and the other end of the tension spring 145 is attached to the attachment portion 144D. Thus, the attachment portion 144D is pulled by the tension spring 145 in the Z direction and the second engagement portion 144A is positioned near the annular member 146.

The handover portion 150 includes the contact member 148 and the above-described transfer-drum driver 50. The contact member 148 is disposed outside the annular member 146 in the Z direction but near the annular member 146. The contact member 148 is made of rubber and has a circular (annular) shape when viewed in the radial direction. When the transfer drum 30 is rotated, the contact member 148 comes into contact with the wide portion 142B of the first support member 142 and moves the first engagement portion 142A inward in the Z direction. Thus, at a certain position in the circumferential direction, the contact member 148 moves the first support member 142 to a position at which the trailing-end gripper 134 may be supported by the second support member 144.

### Operation

The operation of the second exemplary embodiment will now be described.

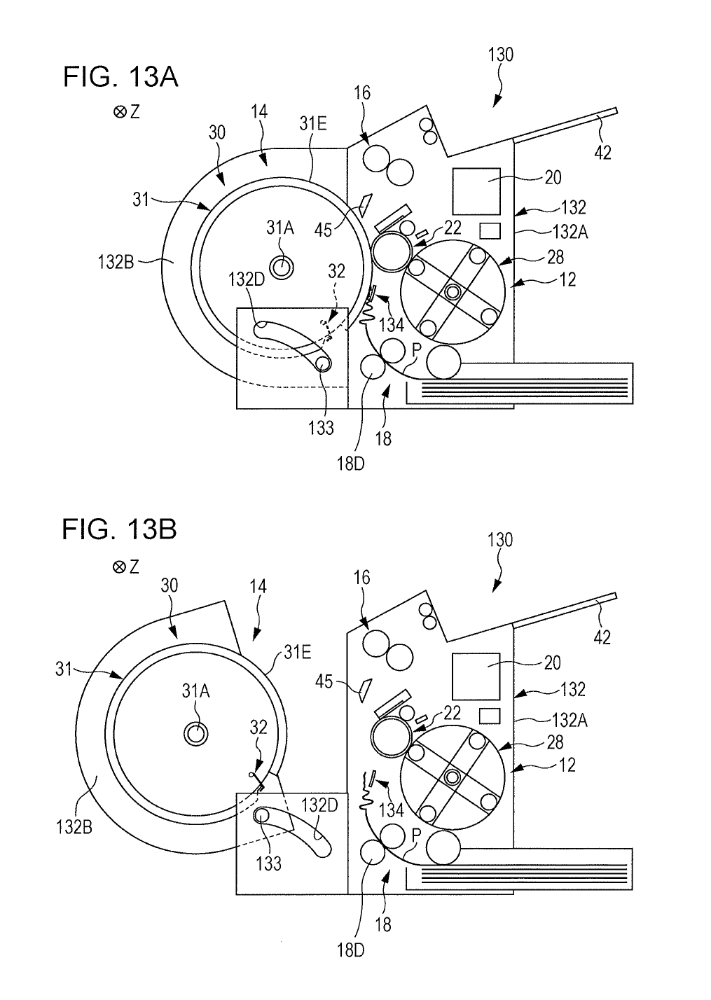

As illustrated in FIG. 13A, when a transfer jam occurs in the image forming apparatus 130, the image forming apparatus 130 stops while the sheet of recording paper P is caught by the trailing-end gripper 134. At this time, the trailing-end gripper 134 is at the retaining position for retaining the sheet of recording paper P. The paper detection sensor 36 (see FIG. 1) is not illustrated in FIGS. 13A and 13B.

Referring to FIG. 12A, the transfer-drum driver 50 (see FIG. 4A) rotates the transfer drum 30 in the −B direction. Accordingly, as illustrated in FIG. 12B, the contact member 148 comes into contact with the wide portion 142B of the first support member 142 and rotates the first support member 142 so that the second projection 135A and the first projection 136A are moved inward in the Z direction beyond the annular member 146 (the paper retainer 34C is bent in this state).

Subsequently, as illustrated in FIG. 12C, the transfer drum 30 is further rotated in the −B direction, so that the second projection 135A, which is positioned on the inner side of the annular member 146 in the Z direction, moves over the wide portion 144B of the second support member 144 and engages with the second engagement portion 144A.

Subsequently, as illustrated in FIG. 12D, the transfer-drum driver 50 (see FIG. 4A) rotates the transfer drum 30 in the +B direction. At this time, the second support member 144 remains retained at the original position and the first support member 142 moves together with the transfer drum 30 in the +B direction. Accordingly, the second projection 135A is restrained from moving in the +B direction by the second engagement portion 144A of the second support member 144, and is supported while being engaged with or connected to the second engagement portion 144A. The first support member 142 is moved in the +B direction while the first projection 136A is released or disengaged therefrom. Thus, the trailing-end gripper 134 is handed over from the first support member 142 to the second support member 144. The transfer drum 30 is stopped after being rotated in the +B direction by a preset distance.

Subsequently, as illustrated in FIG. 13B, when a user (not shown) pulls an upper part of the movable portion 132B toward himself or herself (leftward in FIG. 13B), the movable portion 132B moves so as to open the upper side. At this time, the trailing-end gripper 134 has already been handed over to the second support member 144 (body portion 132A), as illustrated in FIG. 12D. Therefore, the gap between the outer peripheral surface 31E of the transfer drum 30 and the trailing-end gripper 134 is increased.

Thus, the handover structure 140 (see FIG. 12A) allows the transfer drum 30 to be separated from the trailing-end gripper 134 so that the gap between the transfer drum 30 and the trailing-end gripper 134 is increased from the original gap (gap in the normal image forming operation). Therefore, the jammed sheet of recording paper P may be easily taken out from the image forming apparatus 130. Since it is not necessary to pull out the sheet of recording paper P with a large force, the paper retainer 34C of the trailing-end gripper 134 may be prevented from being damaged. Although a transfer jam has been explained as an example, this also applies to the case of a separation jam.

As illustrated in FIGS. 13A and 13B, in the image forming apparatus 130, the trailing-end gripper 134 is handed over to the body portion 132A. Therefore, the trailing-end gripper 134 is not affected even when the transfer drum 30 is largely separated from the body portion 132A. Therefore, the gap between the transfer drum 30 and the trailing-end gripper 134 may be further increased and the sheet of recording paper P may be more easily removed.

In the image forming apparatus 130, the transport rollers 18D and the second support member 144 (see FIG. 12A) are both provided on the apparatus frame 139. The transfer jam may occur while the sheet of recording paper P is nipped by the transport rollers 18D at an end thereof. Even in such a case, since the positional relationship between the trailing-end gripper 134 and the transport rollers 18D does not change, the sheet of recording paper P may be removed without being impeded by the trailing-end gripper 34. Furthermore, since the positional relationship between the sheet of recording paper P and the paper retainer 34C does not change, the paper retainer 34C may be prevented from being damaged and the sheet of recording paper P may be prevented from being cut.

Referring to FIG. 12D, to return the trailing-end gripper 134 to the original position (to the first support member 142), the transfer drum 30 is rotated in the −B direction so that the first projection 136A and the first engagement portion 142A of the first support member 142 are engaged with or connected to each other. Then, the second projection 135A pushes the second engagement portion 144A so as to rotate the second support member 144 in a direction for moving the second projection 135A out of the second support member 144. Thus, the second projection 135A is released or disengaged from the second engagement portion 144A.

As illustrated in FIG. 10A, in the image forming apparatus 130, for example, the trailing-end gripper 134 is handed over from the first support member 142 to the second support member 144 when the trailing-end gripper 134 is at the standby position, which is a position downstream of the paper detection sensor 36 along the feed path 40.

The present invention is not limited to the above-described exemplary embodiments.

As another example of the allowing unit and the handover unit, electromagnets may be used to perform the handover process by turning off the electricity to the first support member to cancel the connected (supported) state of the trailing-end gripper 134 and turning on the electricity to the second support member to establish the connected (supported) state of the trailing-end gripper 134.

Alternatively, the first support member may be moved by using an actuator or an eccentric cam instead of the contact member 148.

Furthermore, the recording-medium transporting member is not limited to the transfer drum 30, and may instead be a transport roller that is used simply to transport the sheet of recording paper P.

The trailing-end gripper may be moved between the retaining position and the separate position either by moving the trailing-end gripper with respect to the transfer drum 30 in the radial direction as in the first exemplary embodiment or by changing the tension applied to the trailing-end gripper in the Z direction as in the second exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that is rotatably provided to an apparatus body and carries a developer image;
a recording-medium transporting member configured to be movable between an opposing position at which the recording-medium transporting member opposes the image carrier and a retracted position that is farther from the image carrier than the opposing position, the recording-medium transporting member including a holding portion that holds a leading end of a recording medium, the recording medium being wrapped around an outer peripheral surface of the recording-medium transporting member;
a retaining portion configured to be movable between a retaining position at which the retaining portion retains a trailing end of the recording medium and a separate position that is farther from the recording-medium transporting member than the retaining position, the retaining portion rotating together with the recording-medium transporting member after retaining the trailing end of the recording medium;
a transfer unit that transfers the developer image carried by the image carrier onto the recording medium retained by the recording-medium transporting member at the opposing position; and
an allowing unit that allows the recording-medium transporting member to be separated from the retaining portion so that the retaining portion does not interfere with a transport path of the recording medium when the recording-medium transporting member is moved from the opposing position to the retracted position.

2. The image forming apparatus according to claim 1,
wherein the allowing unit includes
a connecting member, one end of which is connected to an end portion of the recording-medium transporting member in an axial direction and the other end of which is connected to the retaining portion, the connecting member allowing the recording-medium transporting member to be moved relative to the retaining portion, and
a regulating member that is provided to the apparatus body and regulates movement of the retaining portion by coming into contact with the connecting member when the recording-medium transporting member is moved from the opposing position to the retracted position.

3. The image forming apparatus according to claim 1,
wherein the allowing unit includes
a first support portion that is provided to the recording-medium transporting member, the first support portion being engaged with the retaining portion to support the retaining portion when the recording-medium transporting member rotates in a first direction and being disengaged from the retaining portion when the recording-medium transporting member rotates in a second direction that is opposite to the first direction,
a second support portion that is provided to the apparatus body, the second support portion being engaged with the retaining portion to support the retaining portion when the recording-medium transporting member rotates in the second direction and being disengaged from the retaining portion when the recording-medium transporting member rotates in the first direction, and
a handover unit that, when the recording-medium transporting member is moved from the opposing position to the retracted position, comes into contact with the first support potion so as to move the first support potion to a position at which the retaining portion is supportable by the second support portion and causes the recording-medium transporting member to rotate in the second direction so that the retaining portion is handed over from the first support portion to the second support portion.

4. The image forming apparatus according to claim 3,
wherein the apparatus body is provided with a support on which a transport member is rotatably supported, the transport member transporting the recording medium to a position between the image carrier and the recording-medium transporting member, and
wherein the second support portion is provided on the support.
